(19) United States
(12) Patent Application Publication
(10) Pub. No.: US 2018/0326994 A1
(43) Pub. Date: Nov. 15, 2018

(54) AUTONOMOUS CONTROL HANDOVER TO A VEHICLE OPERATOR

(71) Applicant: Toyota Research Institute, Inc., Los Altos, CA (US)

(72) Inventor: Katsuhiro Sakai, Ann Arbor, MI (US)

(21) Appl. No.: 15/593,905

(22) Filed: May 12, 2017

(51) Int. Cl. B60W 50/08; B60W 50/00; G05D 1/00

(52) U.S. Cl. CPC B60W 50/082; B60W 2050/146; G05D 1/0061; G05D 1/0088; B60W 2540/00; B60W 2050/0072; B60W 2420/52; B60W 2710/18; B60W 2710/20; B60W 2750/40; B60W 2540/10; B60W 2540/12; B60W 2540/18; B60W 2550/10; B60W 50/0098

(57) ABSTRACT

A device and method for effecting an autonomous control handover for passing priority control from a vehicle control unit to a vehicle operator are disclosed. In operation, an autonomous control handover event may be detected that operates to prompt a transition from a first vehicle automation level to a second vehicle automation level. In response, a perception-and-cognition of the vehicle operator may occur by sampling user control data generated via a human-machine interface device and producing simulated user control data, which is compared with corresponding autonomous control data generated via a vehicle control unit. When the simulated user control data compares favorably with the corresponding autonomous control data, an autonomous control handover response is generated operable to transition to the second vehicle automation level, and transmitting the autonomous control handover response.

### FIELD

The subject matter described herein relates in general to a handover from autonomous vehicle operation to manual vehicle operation and, more particularly, to a vehicle autonomous handover considering a perception-and-cognition of a vehicle operator.

### BACKGROUND

Automated or autonomous vehicles have been those in which at least some aspects of a safety-critical control function, such as steering, throttle, or braking, may occur without direct driver input.

While operating, an autonomous self-drive systems had conveyed status information to a passenger or operator relating to operational changes that may have required operator input. Such changes may relate to weather conditions, road construction, vehicle collisions, congestion, etc.

Larger operational changes may have prompted changes in control of the vehicle. As the level of vehicle system control may decrease, the level of control of the driver transitions from simply intermittent supervisory vehicle control to primary control of the vehicle. When such a changes had occurred, however, vehicle systems may simply determine whether an operator seat was occupied and/or vehicle control surfaces had contact with an operator (such as touching a steering, acceleration and/or braking interface). Generally, once a driver position was occupied and tactile presence sensed, vehicle systems would relinquish primary vehicle control to the driver position without knowledge of whether the occupant had a level of perception and/or cognition to undertake the task of driving and to address the cause of a larger operational change in control.

It is desirable, prior to a vehicle handover transferring control from an autonomous vehicle system to a vehicle operator, to determine whether an individual occupying the vehicle driver position has the capacity to undertake and receive primary vehicle control.

### SUMMARY

A device and method for effecting an autonomous control handover for passing priority control from a vehicle control unit to a vehicle operator are disclosed.

In one implementation, a method for effecting an autonomous control handover is disclosed. The method includes detecting an autonomous control handover event that operates to prompt a transition from a first vehicle automation level to a second vehicle automation level. In response to the vehicle control handover event, the method assesses a perception-and-cognition of the vehicle operator by sampling user control data generated via a human-machine interface device and producing simulated user control data, and comparing the simulated user control data with corresponding autonomous control data generated via the vehicle control unit. When the simulated user control data compares favorably with the corresponding autonomous control data, the method generates an autonomous control handover response operable to transition to the second vehicle automation level, and transmitting the autonomous control handover response.

In another implementation, a vehicle control unit is disclosed. The vehicle control unit includes a wireless communication interface, a processor, and a memory. The wireless communication interface operates to service communication with a vehicle network. The processor is coupled to the wireless communication interface and for controlling operations of the vehicle control unit. The memory being coupled to the processor, and for storing data and program instructions used by the processor. The processor being configured to execute instructions stored in the memory for effecting an autonomous control handover. The vehicle control unit detects an autonomous control handover event that operates to prompt a transition from a first vehicle automation level to a second vehicle automation level. In response to the vehicle control handover event, the vehicle control unit operates to assess a perception-and-cognition of a vehicle operator by sampling user control data generated via a human-machine interface device and producing simulated user control data, and comparing the simulated user control data with corresponding autonomous control data generated via the vehicle control unit. When the simulated user control data compares favorably with the corresponding autonomous control data, the vehicle control unit generates an autonomous control handover response operable to transition to the second vehicle automation level, and transmitting the autonomous control handover response.

### BRIEF DESCRIPTION OF THE DRAWINGS

The description makes reference to the accompanying drawings wherein like reference numerals refer to like parts throughout the several views, and wherein:

FIG. 1 is a schematic illustration of a vehicle including a vehicle control unit;

FIG. 2 is a block diagram example of vehicle automation levels for the vehicle of FIG. 1;

FIG. 3 is a side view of depicting vehicle operator presence for the vehicle of FIG. 1;

FIG. 4 is a block diagram of the vehicle control unit of FIG. 1 in the context of a network environment;

FIG. 5 is a block diagram of a perception-and-cognition module of the vehicle control unit of FIG. 4;

FIG. 6 is a block diagram of the vehicle control unit of FIG. 4 for effecting an autonomous control handover; and

FIG. 7 shows an example process for effecting the autonomous control handover.

### DETAILED DESCRIPTION

A vehicle control unit for effecting handover from a first autonomous vehicle automation level to a second vehicle automation level is provided. The first vehicle automation level defines a priority vehicle control with a vehicle control unit over the vehicle operation. As may be appreciated, at this level, an automated driving system functions to monitor a driving environment. The second vehicle automation level defines the priority vehicle control with a vehicle operator over the vehicle. As may be appreciated, a human driver monitors the driving environment.

The handover may be based on detection of an autonomous handover event, which may have a handover transition period for bridging a vehicle control handover from the vehicle control unit to full or partial manual control of the vehicle by a vehicle operator.

An aspect of the handover process is to assess a perception-and-cognition of the vehicle operator prior to vehicle control handover to the vehicle operator. While in an autonomous vehicle control, user control data may be sampled and simulated for comparison with corresponding vehicle control data generated via the vehicle control unit. When the sampled user control data compares favorably with the corresponding vehicle control data, the vehicle control unit may generate an autonomous control handover response for moving control priority to a vehicle operator.

To aid the vehicle operator in the handover, simulated operation feedback (steering angle display, speed indicator, etc.) may be provided by the vehicle control unit for operational continuity from the autonomous vehicle control into manual vehicle control by the vehicle operator.

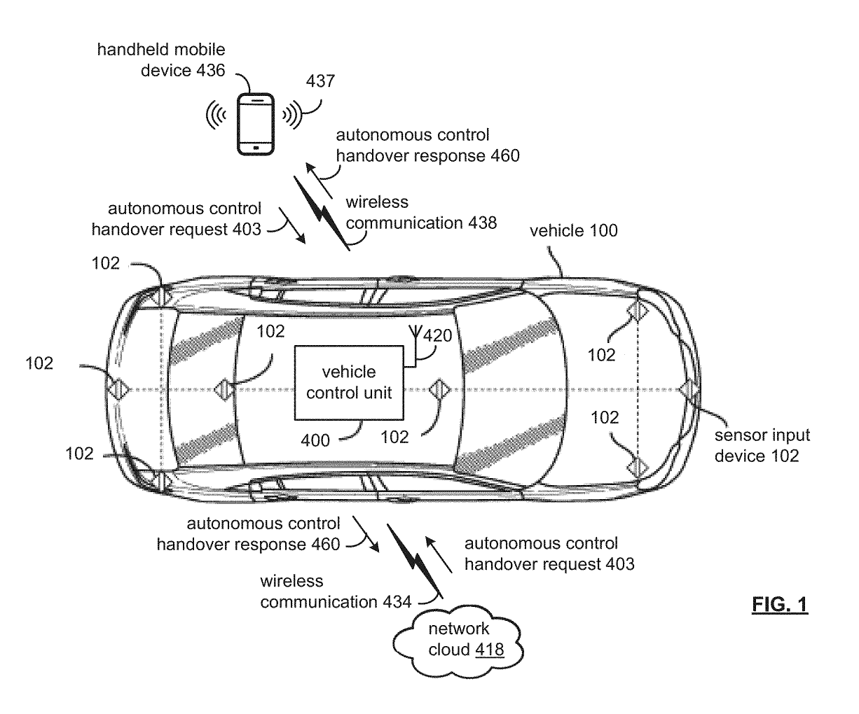

FIG. 1 is a schematic illustration of a vehicle 100 including a vehicle control unit 400. A plurality of sensor input devices 102 are in communication with the vehicle control unit 400. The plurality of sensor input devices 102 can be positioned on the outer surface of the vehicle 100, or may be positioned in a concealed fashion for aesthetic purposes with regard to the vehicle 100. As may be appreciated, the sensor devices 102 may operate at frequencies in which a vehicle body or portions thereof appear transparent to the respective sensor input device 102.

Communication between the sensor input devices 102 may be on a bus basis, and may also be used or operated by other systems of the vehicle 100. For example, the sensor input devices 102 may be coupled by a combination of network architectures such as a Body Electronic Area Network (BEAN), a Controller Area Network (CAN) bus configuration, an Audio Visual Communication-Local Area Network (AVC-LAN) configuration, and/or other combinations of additional communication-system architectures to provide communications between devices and systems of the vehicle 100. Moreover, the sensor devices 102 may be further coupled to the vehicle control unit 400 via such communication-system architectures.

The sensor input devices 102 may operate to monitor ambient conditions relating to the vehicle 100, including visual and tactile changes to a vehicle environment. The sensor input devices 102 may include, for example, video sensor devices (which may be operable in varying frequency spectrums), audio sensor devices, moisture sensor devices, photoelectric sensor devices, etc.

The sensor input devices 102 may convey tactile or relational changes in the ambient conditions of the vehicle, such as an approaching person, object, vehicle, etc. The one or more of the sensor input devices 102 may also be configured to capture changes in velocity, acceleration, and/or distance to these objects in the ambient conditions of the vehicle 100, as well as the angle of approach.

The sensor input devices 102, or a portion thereof, may be provided by a Light Detection and Ranging (LIDAR) system, in which the sensor input devices 102 may capture data related to laser light returns from physical objects in the environment of the vehicle 100. The sensor input devices 102 may also include a combination of lasers (LIDAR) and milliwave radar devices.

Also, the sensor input devices 102, or a portion thereof, may be provided by video sensor devices that associated fields of view. That is, video sensor devices may include three-dimensional fields-of-view having an associated view angle, and a sensor range for video detection.

In various driving modes, video sensor devices may provide for blind-spot visual sensing (such as for another vehicle adjacent the vehicle 100) relative to the vehicle operator, for forward periphery visual sensing of objects outside the forward view of a vehicle operator, such as a pedestrian, cyclist, road debris, unimproved road conditions, construction, etc., that may provoke an autonomous control handover event.

In autonomous operations in which control priority may or may not be assigned to the vehicle control unit 400, the sensor input devices 102 may be further deployed to read lane markings and determine vehicle positions relative to the road to facilitate the relocation of the vehicle 100.

For controlling the volume of data input from the sensor input devices 102, the respective sensitivity and focus of each of the sensor input devices 102 may be dynamically adjusted to limit data acquisition based upon speed, terrain, activity around the vehicle, etc.

For example, for highway driving, the sampling rate of the sensor input device 102 may be reduced to take in less of the ambient conditions in view of the more rapidly changing conditions relative to the vehicle 100, and the range and/or sensitivity extended to provide additional time to process sensed images/objects. In contrast, for residential and/or city driving, the sampling rate may be increased to take in more of the ambient conditions that may change rapidly (such as a child's ball crossing in front of the vehicle, etc.), and the range and/or sensitivity reduced in view of the number of moving objects in close vicinity to the vehicle 100.

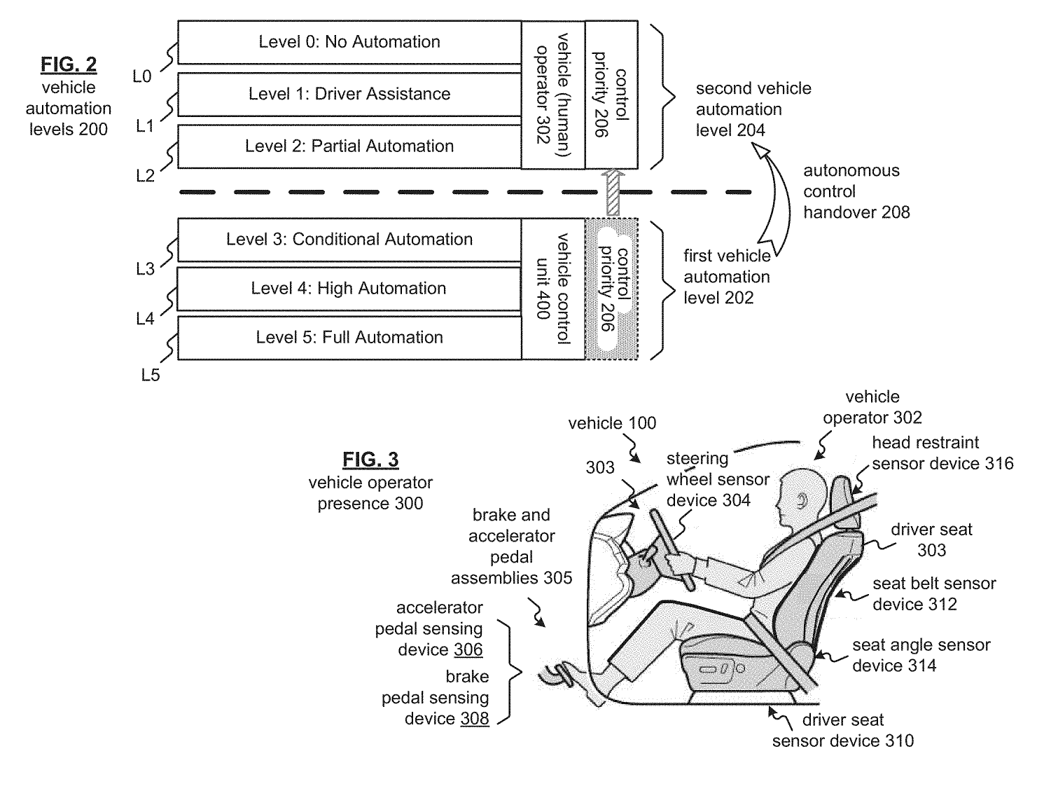

The vehicle 100 may also include options for operating in other than in a full-autonomous control mode, as is explained in detail with reference to FIG. 2. For example, the vehicle 100 may be capable of operation in varying autonomous modes (e.g., fully automated, longitudinal-only, lateral-only, etc.), and/or driver-assist mode. The vehicle 100 may also be operable in a fully-manual mode, in which the vehicle operator manually controls the vehicle systems, such as propulsion systems, steering systems, stability control systems, navigation systems, energy systems, and any other systems that can control various vehicle functions (such as the vehicle climate or entertainment functions, etc.).

The vehicle 100 can also include human-machine interfaces for the vehicle operator to interact with these vehicle systems, for example, one or more interactive displays, audio systems, voice recognition systems, buttons and/or dials, haptic feedback systems, or any other means for inputting or outputting information in relation to the vehicle operator.

In an autonomous mode of operation, the vehicle control unit 400 can be used to control one or more of the vehicle systems without the vehicle operator's direct intervention. Some vehicle control units may also be equipped with a “driver-assist mode,” in which operation of the vehicle 100 may be shared between the vehicle user and a computing device. For example, the vehicle operator can control certain aspects of the vehicle operation, such as steering, while the vehicle control unit 400 can control other aspects of the vehicle operation, such as braking and acceleration.

As shown in FIG. 1, the vehicle control unit 400 may be configured to provide wireless communication 438 with a handheld mobile device 436 through the antenna 420, and to provide wireless communication 434 with a network cloud 418 to access third-party servers for data that may relate to road conditions, weather conditions, etc.

The handheld mobile device 436 may be used by a vehicle operator to issue an autonomous control handover request 403 and receive an autonomous control handover response 460. Third-party servers and data providers may also, based on suitable authentication protocols, generate an autonomous control handover request 403 and receive autonomous control handover responses 460 in view of upcoming conditions contrary to continued autonomous operation of the vehicle 100.

As may be appreciated, the vehicle control unit may be in communication via the wireless communication 438 with other vehicles (for example, vehicle-to-vehicle communications), infrastructure (vehicle-to-infrastructure communications), Internet cloud storage, thin-client and/or thick-client applications, etc.

The autonomous control handover request 403 may be based on one or many autonomous control handover events that may prompts a handover from a first vehicle automation level (that may defines a priority vehicle control and/or driving environment monitoring with the vehicle control unit 400), to a second vehicle automation level (that may define the priority vehicle control and/or driving environment monitoring with a vehicle (human) operator), as is discussed in detail with respect to FIGS. 2-7.

FIG. 2 is a block diagram example of vehicle automation levels 200 for a vehicle 100. In the example of FIG. 2, the vehicle automation levels 200 may include a first vehicle automation level 202 and a second vehicle automation level 204. When operational, the first vehicle automation level 202 defines a vehicle priority control 206 with a vehicle control unit 400. On the other hand, when operational, the second vehicle automation level 204 defines the vehicle control priority 206 with a vehicle operator 302.

A range of autonomous vehicle operation may be defined by industry and/or governmental standards. For example, SAE International (Society of Automotive Engineers International) defines six levels (L0 to L5) of autonomous vehicle operation. As the level of autonomous operation decreases from the greatest automation at level L5 (full automation) to the least automation at level L0 (no automation), the role of the vehicle operator 302 shifts from a supervisory control priority to that of primary control priority 206 for the vehicle 100.

It should be appreciated that although six SAE International automation levels are utilized for example herein, other delineations may additionally or alternatively be provided.

Starting from the lowest level of automation, the second automation level 204 includes Automation Level 0 (L0), Level 1 (L1), and Level 2 (L2). At Automation Level 0 (L0), no automation may be provided by a vehicle control unit 400 for the vehicle 100. The vehicle operator 302 has control priority 206, and is in complete and sole control at all times of the primary vehicle controls and is solely responsible for monitoring the roadway and for safe operation. The primary vehicle controls may include braking, steering, throttle.

A vehicle 100 with vehicle operator 302 convenience systems that do not have control authority over steering, braking, or throttle may still be considered “Automation Level 0” vehicles. Examples of convenience systems may include forward collision warning, lane departure warning, blind spot monitoring, and systems for automated secondary controls such as wipers, headlights, turn signals, hazard lights, etc.

At Automation Level 1 (L1), driver assistance may be provided. At this level, function-specific automation may involve one or more specific control functions, though control priority 206 is with the vehicle operator 302. When multiple functions may be automated, they operate independently and the vehicle operator has overall control. At this level, a vehicle operator may cede limited authority over a primary control such as adaptive cruise control (ACC), automatic braking, lane keeping, etc. Also, automated driver-assist systems may provide added control to aid the vehicle operator 302 in certain normal driving or crash-imminent situations (e.g., dynamic brake support in emergencies). Nevertheless, combinations of systems do not operate in unison that may allow a vehicle operator 302 to disengage from physically operating the vehicle, such as having their hands and feet off of the steering wheel and the pedals at the same time.

At Automation Level 2 (L2), partial automation may be provided. At this level, there may be considered a driver assistance automation. At least two primary control functions may be combined to operate in unison to relieve the vehicle operator 302 of control of those functions (e.g., a combination of adaptive cruise control (ACC) and lane centering), while control priority 206 is with the vehicle operator 302.

The vehicle operator 302 continues monitoring the roadway for safe operation and is expected to be available for control at all times and on short notice because the vehicle control unit may relinquish control with no advance warning and the vehicle operator 302 must be ready to control the vehicle. At Automation Level 2, the vehicle operator 302 may disengaged from physically operating the vehicle with hands and feet off the steering wheel and pedals, respectively, at the same time so that a human driver may perform the remaining aspects of a dynamic driving task.

At either Automation Level 3 (L3), Automation Level 4 (L4), or Automation Level 5 (L5), the priority control 206 is with the vehicle control unit 400 and no longer with the vehicle operator 302.

At Level 3, conditional automation may be provided. At this level, a vehicle operator 302 may cede full control of all safety-critical functions under certain traffic or environmental conditions. That is, an autonomous driving system may perform all aspects of a dynamic driving task with the vehicle (human) operator responding on requests to intervene by the system.

A distinction between Automation Level 2 and Automation Level 3 is that at Automation Level 3, the vehicle operator 302 is not expected to constantly monitor the roadway.

At Automation Level 4 (L4), high automoation may be provided by the vehicle control unit 400. At this level, the vehicle control unit 400 may perform all aspects of the dynamic driving task, even when a vehicle (human) operator 302 may not respond appropriately to a request to intervene. That is, the vehicle 100, via the vehicle control unit 400, may perform safety-critical driving functions and monitors roadway conditions for an entirety of a trip. Such a design anticipates that the vehicle operator 302 (that is, the individual that may activate the automated vehicle system of the vehicle control unit) may provide destination or navigation input, but is not expected to be available for control at any time during the trip (that is, may not respond appropriately to a request to intervene). Automation Level L4 permits occupied and unoccupied vehicles as safe operation rests solely on the automated vehicle system.

At Automation Level 5 (L5), full automation may be provided by the vehicle control unit 400. At this level, the vehicle control unit 400 may perform all aspects of the dynamic driving tasks under a full set of roadway and environmental conditions that can be managed by a vehicle (human) operator 302. In certain aspects, a human operator and/or passenger may not be with the vehicle 100.

Under the autonomous control of Automatic Levels L3 and L4, the vehicle operator 302 may rely more on autonomous operation of the vehicle 100, via the vehicle control unit 400, to detect autonomous handover events that would require an autonomous control handover 208 to return priority control 206 to the vehicle operator 302 (such as in levels L0, L1, and/or L2). At Automatic Level L5, when a vehicle operator 302 may be present, a handover event may be based on a request generated by the vehicle operator 302 (when Human-Machine Interface controls are available). Otherwise, the vehicle 100, via the vehicle control unit 400, may operate without a vehicle (human) operator 302.

An example of a handover event would generally be when the vehicle control unit 400 detects (a) an autonomous control handover request 403 (FIG. 1) at Levels L3, L4 and/or L5, (b) that it is no longer able to support autonomous function at Level L3 and/or Level L4 (such as from road debris and/or oncoming construction area detected by sensor input devices 102 (FIG. 1) and/or may be indicated via a mapping data to a navigation system via network cloud 412 (FIG. 1), (c) the travel conditions deteriorate (such as by weather, poor road upkeep, primitive roads, etc.), that the vehicle control unit 400 may be overwhelmed with a data processing task (such as a buffer overrun, etc.), etc.

The vehicle control unit 400 may operate to assess a presence, and a perception-and-cognition of the vehicle operator 302. Based upon favorable comparisons of these conditions, the vehicle control unit 400 may generate an autonomous control handover response to reengage a vehicle operator 302 in the driving task for Automatic Levels L2 through L0.

Autonomous control handover 208 from automation levels L5 through L3 to levels L2 through L0, may operate to assess human readiness to undertake the driving task from the vehicle control unit 400. The vehicle control unit 400 may operate to assess the vehicle operator's perception-and-cognition prior to engaging in an autonomous control handover 208 that without discerning beforehand, may leave the vehicle operator 302 in a disoriented and/or non-synched state when otherwise expected to reengage the driving task.

By assessing the vehicle operator's perception-and-cognition, the vehicle control unit 400 may operate to verify, in effect, the vehicle operator's a mental readiness. Engaging or touching vehicle human-machine interfaces (such as a steering wheel, accelerator pedal, braking pedal, etc.) alone may be an insufficient indication that the vehicle operator 302 may successfully carry out an autonomous control handover 208, where a successful handover occurs when the transition from machine to human is largely unnoticeable.

A machine-to-human transition may be noticeable, for example, when a vehicle operator 302 recently wakes from a nap, when the steering wheel may be aligned inapposite to the machine-selected direction of travel and then human-machine steerage linkages are re-engaged, and/or when the accelerator pedal may not be in a position to continue the existing machine-selected speed, acceleration and/or deceleration.

Also, as autonomous vehicle operation may become increasingly common, a vehicle operator 302 may become increasingly reliant on the autonomous technology (such as at Level L3, Level L4 and/or Level L5), and an associated degradation of driving skill sets over time. Assessing a vehicle operator's perception-and-cognition before a handover 208 may be further called for by the loss in driving proficiency.

Accordingly, in this context the vehicle control unit 400 is operable to assess the perception-and-cognition of the vehicle operator 302 for an autonomous control handover 208, as discussed in detail with reference to FIGS. 3-7.

FIG. 3 is a side view of depicting vehicle operator presence 300 for a vehicle 100. In general, with autonomous vehicle operation such as automatic levels L5, L4 and/or L3, a vehicle operator 302 may not be in position for assuming control priority of the vehicle 100 in an autonomous handover from a first vehicle automation level to a second vehicle automation level. A vehicle control unit 400 may be operable to poll vehicle operator presence data, in response to a vehicle control handover event, to produce a vehicle operator presence determination based on a presence threshold.

The vehicle 100 may include a driver seat 303, a steering wheel 303, and brake and accelerator pedal assemblies 305. The driver seat 303 includes sensor devices by which the vehicle control unit 400 may poll vehicle operator presence data. The sensor devices may include a driver seat sensor device 310, a seat belt sensor device 312, seat angle sensor device 314, a head restraint sensor device 316, etc., in which each of the devices 310, 312, 314 and 316 may operate to produce respective sensor values 216-310, 216-312, 216-314 and 216-316.

The driver seat sensor device 310 may operate to sense and produce weight data relating to the vehicle operator 302. For identification and/or distinguishing between an adult and a child, for example, the weight data may likely correlate with historical weight data for the vehicle operator 302.

Such historical weight data may be selected based on a biometric identity of the vehicle operator 302 such as iris scan, fingerprint unlock, key fob NFC data, voice recognition, etc.). Alternatively, the driver seat sensor device 310 may assess whether the resulting weight data is within a range associated with one generally capable of operating the vehicle 100 if a vehicle control handover was to occur (such as an adult).

The seat belt sensor device 312 and the seat angle sensor device 314 may further operate to detect whether the vehicle operator 302 is in a posture to operate the vehicle 100. For example, the seat angle sensor device 314 and the driver seat sensor device 310 may generate presence data indicating that the vehicle operator 302 is sitting upright and back in the driver seat 303. Further sensor devices may be provided to sense the forward or backward position of the vehicle seat 303 to sense that the brake and accelerator pedal assemblies 305 may be reached and easily depressed by the vehicle operator 302 to the extent required.

The steering wheel sensor device 304 may be operable to produce vehicle operator presence data relating to tilt-and-telescopic positions of the steering wheel 303 such that an airbag safety device is directed towards the vehicle operator 302. The steering wheel sensor device 304 may be further operable to generate data relating to the steering wheel angle of the steering wheel 303.

The head restraint sensor device 316 may be operable to produce operator presence data indicating the position of the head restraint in such that a center portion is generally adjacent the top of the vehicle operator's ears to cradle and/or support the operator's head.

The vehicle control unit is operable to poll, in response to a vehicle control handover event, data of the sensor devices 304, 310, 314 and 316 relating to the vehicle operator presence 300, and the operator's position with respect to human-machine interface devices such as the steering wheel 303 and brake and accelerator pedal assembly 305.

The vehicle control unit may then compare the polled vehicle operator presence data produced by the sensor devices 304, 310, 314 and 316 with a presence threshold to produce a vehicle operator presence determination.

The presence threshold may be a cumulative weighting of sensor data values indicative of the vehicle operator 302 having a presence in the vehicle 100 for undertaking control priority 206 (FIG. 2) from the vehicle control unit. As may be appreciated, different weighting values may be provided for each of the sensor devices 304, 310, 314 and 316, to indicate some having a emphasis for the operator posture in the driver seat 303 (for example, the driver seat sensor device 310 and seat angle sensor 314 may be considered to be principle sensor values for a presence threshold).

When a vehicle operator presence determination operates to indicate a current vehicle operator presence 300 for the driver seat 300, the vehicle control unit may assess a perception-and-cognition of the vehicle operator 302.

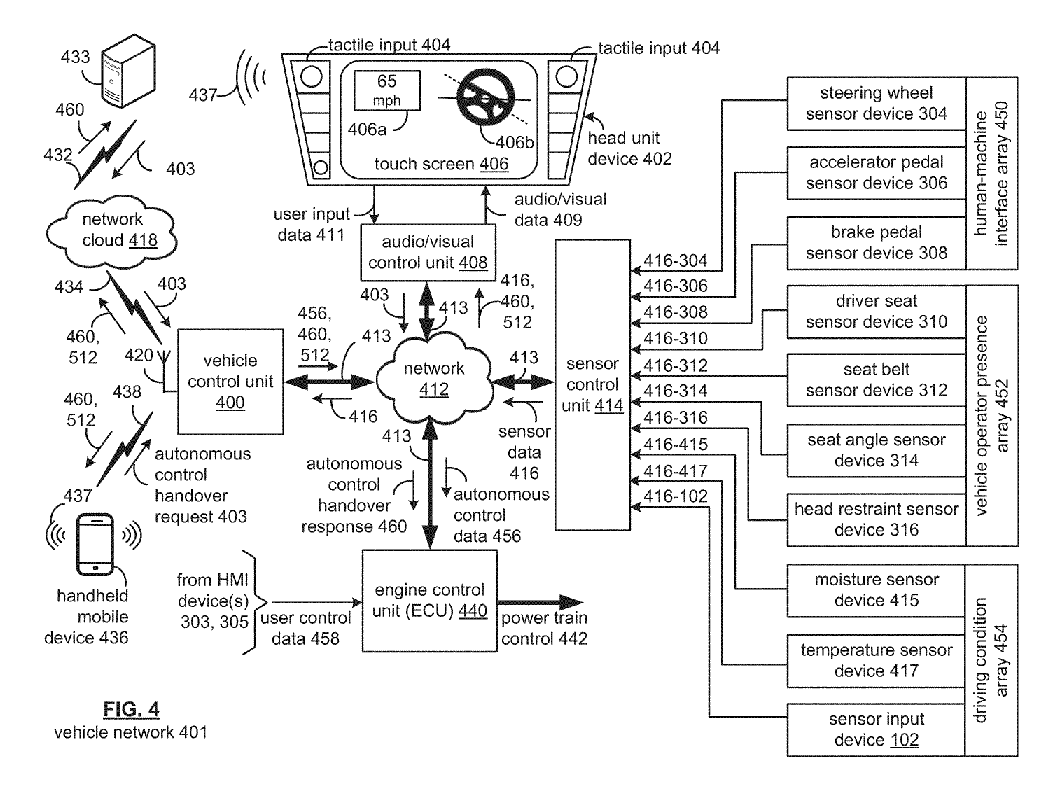

FIG. 4 is a block diagram of a vehicle control unit 400 in the context of a network environment 401. While the vehicle control unit 400 is depicted in abstract with other vehicular components, the vehicle control unit 400 may be combined with system components of the vehicle 100 (see FIG. 1). Moreover, the vehicle 100 may also be an automobile or any other passenger or non-passenger vehicle such as, for example, a terrestrial, aquatic, and/or airborne vehicle.

As shown in FIG. 4, the vehicle control unit 400 communicates with a head unit device 402 via a communication path 413, and also communicatively coupled with a network cloud 418 via an antenna 420 and wireless communication 434. The antenna 420 may also operate to provide communications by the vehicle control unit 400 through vehicle-to-vehicle (V2V) communications, through (V2I) vehicle-to-infrastructure communications, as well as via the wireless communications 438 and 434.

In this manner, the vehicle control unit 400 may operate to receive input data, and provide data to, the vehicle head unit 402, audio/visual control unit 408, the sensor control unit 414, the engine control unit (ECU) 440, and other devices that may communicatively couple via the network could 418, such as computer, a handheld mobile device 436 (for example, cell phone, a smart phone, a personal digital assistant (PDA) devices, tablet computer, e-readers, laptop computers, etc.), a third-party service via server 433 for autonomous vehicles that may include navigation, weather, construction, and other forms of data related to vehicle terrain and conditions.

For clarity, sensor devices are grouped in categories including a human-machine interface array 450, a vehicle operator presence array 452, and a driving condition array 454 to produce respective sensor data 416 to the sensor control unit 414 and to the network 412 via communication links 413, and accessible by the vehicle.

The human-machine interface array 450 relates to sensor devices responsive to vehicle operator manipulation of vehicle control surfaces. For example, human-machine interface array 450 may include steering wheel sensor device 304, accelerator pedal sensor device 306, and brake pedal sensor device 308.

The steering wheel sensor device 304 may operate to produce data 415-304 including a steering wheel angle that may be altered by a vehicle operator 302. The accelerator pedal sensor device 306 may operate produce data 416-306 indicating a pedal position and corresponding speed instruction to the vehicle 100 via the ECU 440. The brake pedal sensor device 308 may operate to produce data 416-308 indicating a corresponding pedal position and corresponding deceleration control data for the vehicle 100 to a braking control unit and/or transmission control unit, for example.

Vehicle operator presence array 452 relates to sensor devices for the vehicle control unit 400 to poll for vehicle operator presence data to determine a current vehicle operator presence 300 (see FIG. 3). For example, vehicle operator presence array 452 may include driver seat sensor device 310, seat belt sensor device 312, seat angle sensor device 314, head restraint sensor device 316, etc.

The driver seat sensor device 310 may operate to produce data 416-310 that the vehicle control unit 400 may poll to indicate the weight of a vehicle operator generally, or in relation to a graduated pressure across a driver seat (for example, indicating whether the driver's posture corresponds to assuming priority control of the vehicle 100). The seat belt sensor device 312 may operate to produce data 416-312 that the vehicle control unit 400 may poll to indicate the status of the seat belt restraining device for the occupant of the driver seat. The seat angle sensor device 314 may operate to produce data 416-312, and the head restraint sensor device 316 may operate to produce data 416-415, each of which the vehicle control unit 400 may poll to determine whether the vehicle operator is in an upright position and/or posture indicative of a presence to assume priority control over the vehicle 100.

Driving condition array 454 relates to sensor devices for the vehicle environmental and/or roadway conditions, and detecting, by the vehicle control unit 400, an autonomous control handover event of a plurality of autonomous control handover events. Also, the driving condition array 454 provides the vehicle control unit 400 a basis for determining a handover transition period for effecting an autonomous control handover to a vehicle operator 302 in view of a detected autonomous control handover

For example, the driving condition array 454 may include a moisture sensor device 415, a temperature sensor device 417, a sensor input device 102, etc.

The moisture sensor device 415 may operate to produce data 416-415, which indicates rainfall, snowfall, fog, or other forms of precipitation. The temperature sensor device 417 my operate to produce data 416-417, which indicates an ambient temperature around the vehicle 100 that may affect driving conditions, such as temperatures falling below freezing (or excessive heat, which may overload the autonomous system with thermal runaway conditions to the processors). The sensor input device 102 may operate to produce data 416-102, which relates to object detection and/or lane detection for the roadway, as well as obstruction hazards (such as road debris, pedestrians, other motorists, etc.).

With the sensor data 416 from the driving condition array 454 of moisture sensor device 415, temperature sensor device 417, sensor input device(s) 102, etc. The vehicle control unit 400 may operate to detect an autonomous control handover event by sensing lane markings, determine vehicle positions with the road to facilitate the autonomous control of the vehicle 100 with Automatic Levels L3, L4 and/or L5.

For further example, the vehicle sensor data 416 operates to permit external object detection through the vehicle control unit 400. External objects may include other vehicles, roadway obstacles, traffic signals, signs, trees, etc. In this manner, the sensor data 216 may allow the vehicle 100 (see FIG. 1) to assess its environment and react to increase safety for vehicle passengers, external objects, and/or people in the environment.

On a driving target basis, autonomous decision devices of the vehicle control unit 200 effects autonomous vehicle control. Differing from the local sensory basis discussed above, a driving target basis considers a top view as a vehicle 100 traverses a travel route of a map.

When in an autonomous mode of operation (such as automatic level L5, L4 and/or L3), the vehicle control unit 400 may operate to generate a functional response as vehicle control data 456 (such as velocity, acceleration, steering, braking, and/or a combination thereof, etc.) provided to the powertrain control units such as engine control unit (ECU) 440 to produce powertrain control 442, as well as to a transmission control unit, a steering control unit, etc.

The term “powertrain” as used herein describes vehicle components that generate power and deliver the power to the road surface, water, or air. The powertrain may include the engine, transmission, drive shafts, differentials, and the final drive communicating the power to motion (for example, drive wheels, continuous track as in military tanks or caterpillar tractors, propeller, etc.). Also, the powertrain may include steering wheel angle control, either through a physical steering wheel of the vehicle 100, or via drive-by-wire and/or drive-by-light actuators.

Still referring to FIG. 4, the audio/visual control unit 408 operates to provide, for example, audio/visual data 409 for display to the touch screen 406, as well as to receive vehicle control data 456 for display to the touch screen 406 as a graphic user interface representation of vehicle operation in a first vehicle automation level 202 during which the vehicle control unit 400 has priority control over the vehicle 100, and/or a second vehicle automation level 204 during which the vehicle operator 302 has priority control over the vehicle 100. In other words, the audio/visual control unit 408 operates to present audio/visual data 409 to the touch screen 406 driving status recognition data (such as vehicle speed display 406a, steering wheel angle display 406b, etc. via sensor data 416),

The server 233 may be communicatively coupled to the network cloud 418 via wireless communication 432. The server 433 may include third-party servers that are associated with applications that running and/or executed on the handheld mobile device 436, the vehicle head unit 402, the vehicle control unit 400, etc.

For example, application data that may be associated with a first application running on the vehicle control unit 400 and/or the handheld mobile device 436 (e.g., OpenTable) may be stored on the server 433. The server 433 may be operated by an organization that provides the application, and application data associated with another application running on the handheld mobile device 436 or the server 433, and also be stored on yet another server. It should be understood that the devices discussed herein may be communicatively coupled to a number of servers by way of the network cloud 418.

The vehicle control unit 400 may operate to retrieve location data for the vehicle 100, via global positioning satellite (GPS) data. Based on the vehicle location data, the vehicle control unit 400 may request map layer data via third-party server 433 relating to present traffic speeds for a roadway relative to a free-flowing traffic speed, as well as traffic incident locations, construction location, etc. The driving map data may be used by the vehicle control unit 400 to detect an autonomous control handover event from a first to a second vehicle automation level.

The driving map data may further be indicative of the positioning of the vehicle 100 with respect to travel route data, in which a vehicle position can be indicated on a map displayed via the touch screen 406, or displayed via the display screens via the handheld mobile device 436 over wireless communication 436.

The server 433 may be operated by an organization that provides mapping application and map application layer data including roadway information data, traffic layer data, geolocation layer data, etc. Layer data may be provided in a Route Network Description File (RNDF) format. A Route Network Description File specifies, for example, accessible road segments and provides information such as waypoints, stop sign locations, lane widths, checkpoint locations, and parking spot locations.

Servers such as server 433 may also provide data as Mission Description Files (MDF) for autonomous vehicle operation. A Mission Description Files (MDF) may operate to specify checkpoints to reach in a mission, such as along a travel route. It should be understood that the devices discussed herein may be communicatively coupled to a number of servers by way of the network cloud 218.

The touch screen 406 operates to provide visual output or graphic user interfaces such as, for example, maps, navigation, entertainment, information, infotainment, and/or combinations thereof. The touch screen 406 may include mediums capable of transmitting an optical and/or visual output such as, for example, such as a liquid crystal display (LCD), light emitting diode (LED), plasma display or other two dimensional or three dimensional display that displays graphics, text or video in either monochrome or color in response to display audio/visual data 209.

Moreover, the touch screen 406 may, in addition to providing visual information, detect the presence and location of a tactile input upon a surface of or adjacent to the display. The tactile input may presented to a user by devices capable of transforming mechanical, optical, or electrical signals into a data signal capable of being transmitted via the communication path 413 by the audio/visual control unit 408.

Tactile input may be solicited from a vehicle operator and/or user based on a number of movable objects that each transform physical motion into a data signal that can be transmitted over the communication path 413 such as, for example, a button, a switch, a knob, a microphone, etc. Accordingly, the graphic user interface may receive mechanical input directly upon the visual output provided by the touch screen 406.

Also, the touch screen 406 may include at least one or more processors and one or more memory modules for displaying and/or presenting the audio/visual data 409 from the audio/visual control unit 408, and to receive and provide user input data 411 to the vehicle network 401 via the network 412.

As may be appreciated, the communication path 413 of the vehicle network 401 may be formed by a medium suitable for transmitting a signal such as, for example, conductive wires, conductive traces, optical waveguides, or the like. Moreover, the communication path 413 can be formed from a combination of mediums capable of transmitting signals. In one embodiment, the communication path 413 may include a combination of conductive traces, conductive wires, connectors, and buses that cooperate to permit the transmission of electrical data signals to components such as processors, memories, sensors, input devices, output devices, and communication devices.

Accordingly, the communication path 413 and network 412 may be provided by a vehicle bus structure, or combinations thereof, such as for example, a Body Electronic Area Network (BEAN), a Controller Area Network (CAN) bus configuration, an Audio Visual Communication-Local Area Network (AVC-LAN) configuration, a Local Interconnect Network (LIN) configuration, a Vehicle Area Network (VAN) bus, and/or other combinations of additional communication-system architectures to provide communications between devices and systems of the vehicle 100.

The term “signal” relates to a waveform (e.g., electrical, optical, magnetic, mechanical or electromagnetic), such as DC, AC, sinusoidal-wave, triangular-wave, square-wave, vibration, and the like, capable of traveling through at least some of the mediums described herein.

The wireless communication 434 and 438 may be based on one or many wireless communication system specifications. For example, wireless communication systems may operate in accordance with one or more standards specifications including, but not limited to, 3GPP (3rd Generation Partnership Project), 4GPP (4th Generation Partnership Project), 5GPP (5th Generation Partnership Project), LTE (long term evolution), LTE Advanced, RFID, IEEE 802.11, Bluetooth, AMPS (advanced mobile phone services), digital AMPS, GSM (global system for mobile communications), CDMA (code division multiple access), LMDS (local multi-point distribution systems), MMDS (multi-channel-multi-point distribution systems), IrDA, Wireless USB, Z-Wave, ZigBee, and/or variations thereof.

As is noted above, the vehicle control unit 400 may be communicatively coupled to a handheld mobile device 436 via wireless communication 438, a network cloud 418 via a wireless communication 434, etc.

The handheld mobile device 436, by way of example, may be a device including hardware (for example, chipsets, processors, memory, etc.) for communicatively coupling with the network cloud 218, and also include an antenna for communicating over one or more of the wireless computer networks described herein.

As may be appreciated, the vehicle control unit 400 may operate to provide autonomous vehicle control, such as at Automatic Levels L3, L4 and/or L5, and aspects of Automatic Levels L2 and L1, on a local sensory basis via sensor devices of driving condition array 454, on a driving target basis provided via a touch screen 406 of the head unit device 402, via the mobile handheld device 436, and/or a combination thereof.

The vehicle control unit 400 also provides for effecting an autonomous control handover from a first vehicle automation level (such as Level L5, Level L4 and/or Level L3) to a second automation level (such as Level L2, Level L1 and/or Level L0), in which a control priority may pass from the vehicle control unit 400 to a vehicle operator 302 (see FIG. 3).

As may be appreciated, the respective graphic user interface representations for first and second vehicle automation levels 202 and 204 may presented alone or in combination for visual, haptic and/or audible feedback to a vehicle operator 302 (FIG. 3) during an autonomous control handover 208 (FIG. 2), and also for the vehicle control unit 400 to assess a perception-and-cognition of the vehicle operator for effecting an autonomous control handover.

In operation, the vehicle control unit 400 may detect an autonomous control handover event and a handover transition period. The autonomous control handover event prompts a transition from a first vehicle automation level to a second vehicle automation level, such as that discussed in reference to FIG. 2, which may be announced to the vehicle operator 302 visually and/or audibly to the vehicle operator 302. For example, the vehicle control unit 400 communicates a required engagement level so that the driver is specifically instructed as to the appropriate level of engagement with the HMI device(s) 303, 305.

An autonomous control event may include receiving an autonomous control handover request 403, detecting an adverse driving condition event, detecting a vehicle system overload event, etc.

The vehicle control unit 400 operates to poll, in response to the vehicle control handover event, vehicle operator presence data via the vehicle operator presence array 452, and compares the vehicle operator presence data (such as driver seat sensor device data 416-310, seat belt sensor device data 416-312, seat angle sensor device data 416-314, head restraining sensor device data 416-316, etc.) with a presence threshold to produce a vehicle operator presence determination.

The presence threshold may be based on a singular and/or multiple values relating to the vehicle driver seat 303. For example, the presence threshold may be based on desired measured values, such as a driver seat sensor value indicative of an adult occupying the driver seat 303 (based on statistical values and/or measured values provided as a user input parameter), a seat angle sensor value indicating a value and/or range of values indicating a sufficiently upright position to operate the vehicle 100. Other values may be binary in nature, such as a seat belt value and/or head restraint value “TRUE” when engaged or “FALSE” when not engaged. The values for each may be cumulative, weighted, or subsets used to determine the vehicle operator presence 300 (FIG. 3).

When the vehicle operator presence determination operates to indicate a current presence of a vehicle operator 302 (FIG. 3), the vehicle control unit 400 assesses a perception-and-cognition of the vehicle operator 302. In this regard, the vehicle control unit 400 operates to verify, in effect, a mental readiness of the operator for the driving task. Engagement and/or a touch by the operator of the vehicle human-machine interface devices 303, 305 alone do not convey a mental readiness of the vehicle operator to assume priority control over the vehicle 100.

For example, a vehicle operator 302 may not have a sufficient level of mental readiness such as waking from a nap, or unknowingly having the steering wheel misaligned with the current direction of travel, and/or the accelerator pedal not engaged at a level to continue the existing speed, acceleration and/or deceleration.

Also, as vehicle operators 302 may become over-reliant on autonomous vehicle technologies, their driving skill sets may degrade over time with less and less frequency of manually controlling the vehicle 100.

That is, when vehicle operators 302 may become over reliant on autonomous modes (such as L3 or L4) for extended periods of time, their driver skills may degrade because of the frequent disengagement from the driving task. Accordingly, in this context as well as general driving capability of a prospective vehicle operator 302, the vehicle control unit 400 is operable to assess the perception-and-cognition of the vehicle operator 302 prior to an autonomous control handover 208 (see FIG. 2).

During the first vehicle automation level (such as Level L3, Conditional Automation, Level L4 High Automation or Level L5, Full Automation), the HMI device(s) 303, 305 may generate user control data 458 that can be sensed via the human-machine interface array 450; however, the engine control unit 440 may not operate on some or all of the user control data 458, based on the automation configurations for respective vehicle automation level 200 being applied to the vehicle 100 (that is, Levels L0 to L5 (FIG. 2)).

For example, at Level L4 for High Automation and/or Level L5 for Full Automation, data 458 generated by the HMI devices 303, 305 can be disregarded (or discarded) by the engine control unit 440. That is, at Level L4 and L5, the engine control unit 456 receives, and acts on the autonomous control data 456 produced by the vehicle control unit 400 for producing powertrain control 442.

Visual and/or audio feedback of vehicle speed, steering wheel angle, etc., may be provided to the vehicle operator 302, such as through the touch screen 406 and/or speakers 437 of the head unit 202, and/or the handheld mobile devices 436.

For example, the touch screen 406 may communicate sensor data 416 via a vehicle speed display 406a (as may be relayed by a vehicle speed sensor (VSS) device) and a steering wheel angle display 406b showing a “virtual” steering wheel position controlled by the vehicle control unit 400 indicated by the solid line, and an “actual” steering wheel position of the steering wheel 300 indicated by the dashed line.

Alternatively, or in combination, the head unit 402 may provide audible speaker signals 437 (such as “speed is at 65 miles-per-hour” “steering wheel is uncentered”, etc.). Such data may also be conveyed via the mobile handheld device 436, a heads-up display, an instrument panel, etc.

The vehicle control unit 400 may operate to simulate the vehicle operator inputs from the HMI device(s) 303, 305, as sensed via the human-machine interface array 450. The human-machine interface array 450 may include a steering wheel sensor device 304 to produce data 416-304, a speed sensor device 306 to produce data 416-306, and a brake pedal sensor device 308 to produce data 416-308.

In operation, while at a first vehicle automation level (which may be either Level L3, Level L4 or Level L5 per the example of FIG. 2), the vehicle control unit 400 operates to sample user control data 458 generated via a human-machine interface device(s) 303, 305, to produce simulated control data. The simulated control data provides values for comparison by the vehicle control unit 400 with the autonomous control data 456.

Also, the vehicle control unit 400 may provide the vehicle operator 302 with feedback for assessing the perception-and-cognition of the vehicle operator.

For example, the simulated control data may be provided to the audio/visual control unit 408 to provide a reference with the corresponding vehicle operation, such as speed and steering wheel angle.

For example, the color of the vehicle speed display 406a may transition to green as a simulated user control data based on a position of the brake and accelerator pedal assemblies 305 compares favorably with the vehicle speed value produced by the autonomous control data 456. Also, graphics indicating simulated (or virtual) versus actual alignment for the steering wheel angle display 406b come into alignment to indicate that the actual alignment for the steering wheel 303 compares favorably with the steering wheel angle produced by the autonomous control data 456.

When simulated user control data compares favorably with the corresponding autonomous control data, and the handover transition period has not lapsed, the vehicle control unit 400 operates to generate an autonomous control handover response operable to perform an autonomous control handover from the first vehicle automation level to the second vehicle automation level.

The vehicle control unit 400 operates to transmit the autonomous control handover response, which may be via the network 412 to be received by the engine control unit (ECU) 440. The engine control unit 400 may operate to transition to receive user control data 458 based on an autonomous configuration as set out by the response 460. The autonomous control handover response 460 may also be conveyed to the vehicle operator via the user interfaces of the head unit 402, the handheld mobile device 436, etc., for announcing a status of the handover transition (for example, “handover completed,” “handover suspended,” etc.).

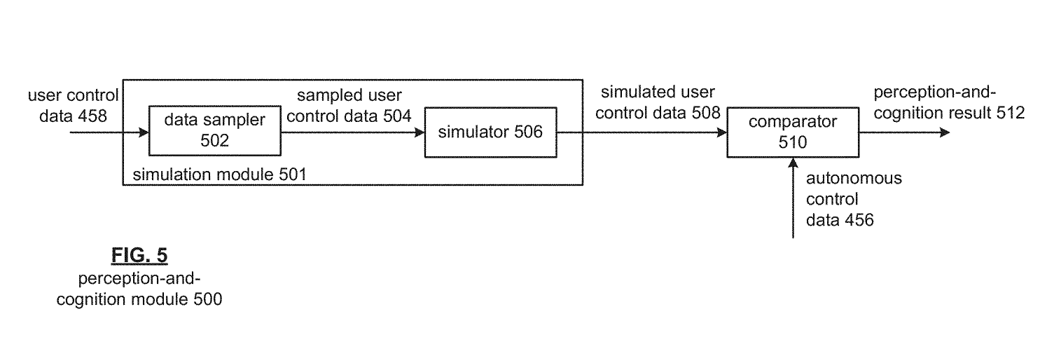

FIG. 5 is a block diagram of a perception-and-cognition module 500 of the vehicle control unit 400. The module 500 may include a simulation module 501 and a comparator 510.

The simulation module 501 includes a data sampler 502 and a simulator 506. The data sampler 502 may operate to receive user control data 458 and produce sampled user control data 504. The user control data 458 may be provided as sensor data 416 via a human-machine interface array 450. For example, user control data 458 may include data 416-304 from steering wheel sensor device 304, data 416-306 from accelerator pedal sensor device 306, data 416-308 from brake pedal sensor device 308, etc., for sensing operation of HMI device(s) 303, 305 (FIG. 3).

The simulator 506 receives the sampled user control data 504 and produces simulated user control data 508. Because portions or all of the user control data 458 may not be acted on by powertrain control unit of the vehicle 100 while the vehicle 100 is in a first vehicle automation level (such as Level L3, Level L4 and Level L5), a vehicle operator “cause-and-effect” may not be sensed by vehicle sensors. For example, a vehicle speed sensor device sensing the vehicle's speed responsive to an accelerator pedal position because the vehicle speed is a function of the autonomous control data 456. Also, a steering wheel angle sensor device sensing the resulting vehicle direction at a gear box relates to the angle indicated by the autonomous control data 456, and may not represent a current position of the steering wheel.

The user control data 458 may be processed by the simulator 506 to produce simulated user control data 508 that simulate autonomous control data 456 output by an autonomous vehicle control device, which in the present embodiment may be provided by the vehicle control unit 400.

A comparator 510 operates to compare the simulated user control data 508 and the autonomous control data 456 to produce a perception-and-cognition result 512. When the perception-and-cognition result 512 is favorable, the perception-and-cognition of a vehicle operator 302 may be considered such that the vehicle operator 302 may reengage in the driving task for the second vehicle automation level, which in the present embodiments, may include Automatic Level L2 for combined function automation, Level L1 function-specific automation, and Level L0 for no automation. The perception-and-cognition result 512 may be based on some or all of possible operational data related to the task of driving. In general, speed and driving

The simulated user control data 508, the autonomous control data 456, and the perception-and-cognition result 512 may be presented to a vehicle operator 302 to provide a visual feedback, a haptic feedback and/or an audio feedback to the vehicle operator 302 via a head unit 402, a handheld mobile device 436, etc. (FIG. 4).

For example, as the perception-and-cognition result 512 indicates a favorable comparison simulated user control data 508 and the autonomous control data 456, an icon's color for a vehicle speed display may transition to “green”, indicating the vehicle operator's simulated operation of the vehicle 100, such as through a position of the brake and accelerator pedal assemblies 305 (FIG. 3), compares favorably with the vehicle control unit 400 operation of the vehicle. The display may further be accompanied by an audio feedback announcing “handover to manual occur shortly,” as a haptic confirmation via the head unit 402 and/or handheld mobile device 436, etc.

As may be appreciated, the perception-and-cognition module 500 may also operate for a time window defined by a handover transition period. The handover transition period relates to underlying circumstances or urgency corresponding to an autonomous control handover event.

For example, when a detected autonomous control handover event may be receiving an autonomous control handover request, from a vehicle occupant, the handover transition period may be flexible. When the detected autonomous control handover event may be detecting an adverse driving condition event, such as road debris, upcoming roadway congestion, approaching weather, etc., the handover transition may be limited on a range and present velocity of the vehicle 100. A plurality of handover transition periods for events may be accessible locally by the vehicle control unit, or may be provided with the autonomous control handover request (such as via a third-party server providing autonomous services and/or applications to the vehicle 100).

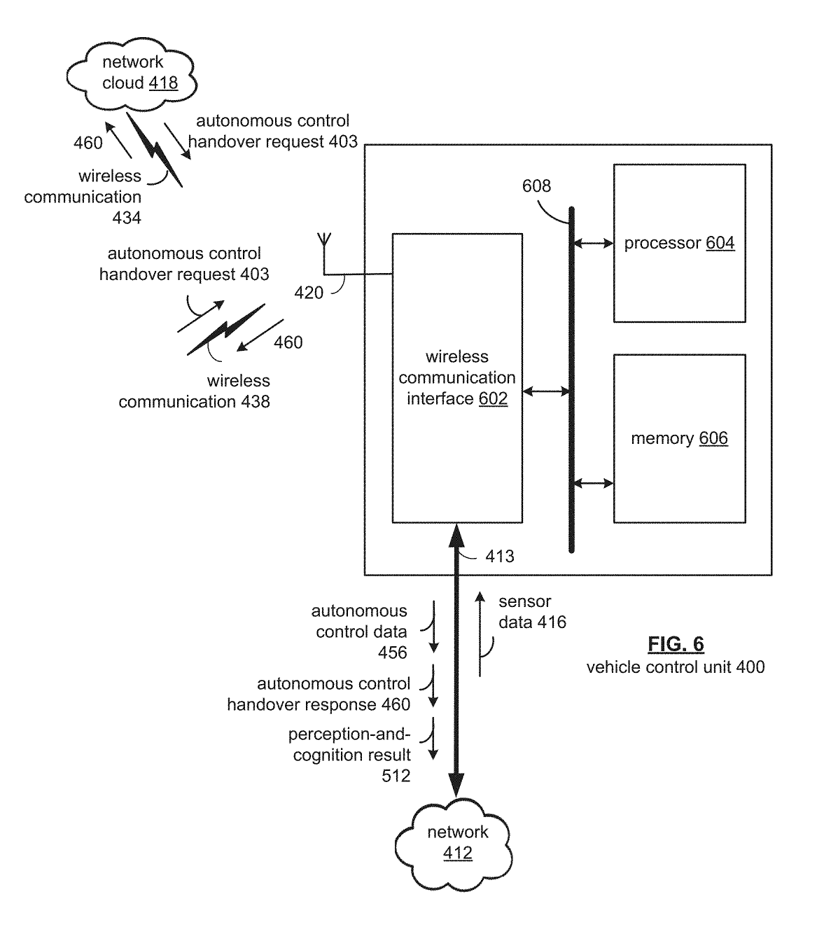

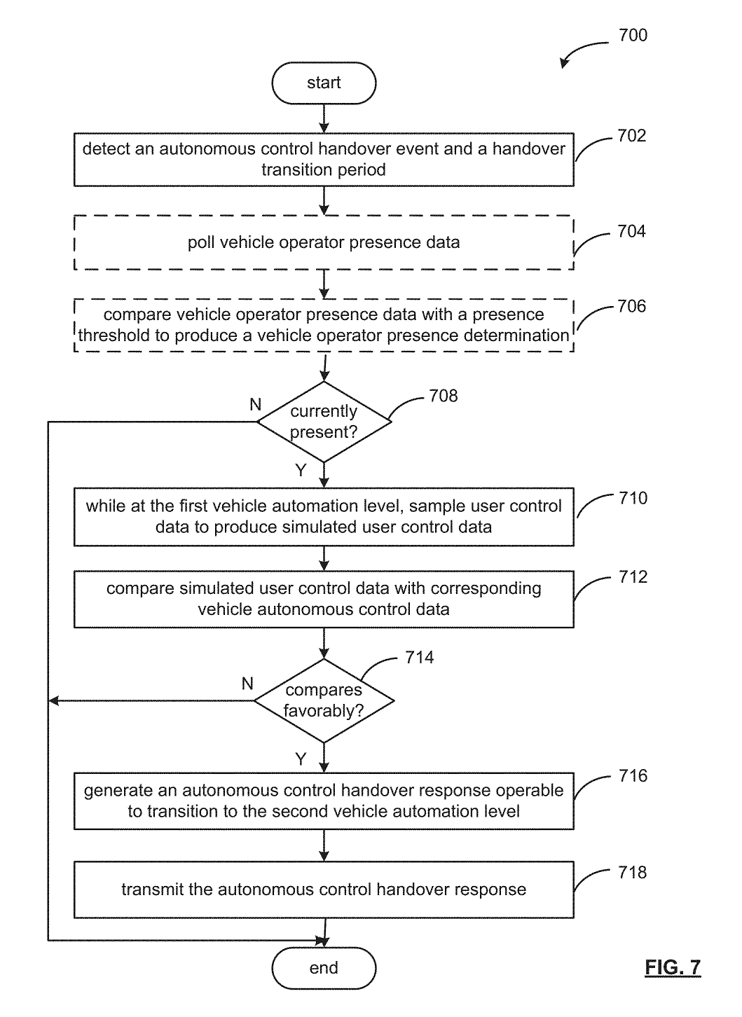

FIG. 6 is a block diagram of a vehicle control unit 400 for effecting an autonomous control handover. The vehicle control unit 400 includes a wireless communication interface 602, a processor 604, and memory 606, that are communicatively coupled via a bus 608.

The processor 604 in the control unit 400 can be a conventional central processing unit or any other type of device, or multiple devices, capable of manipulating or processing information. As may be appreciated, processor 604 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions.

The memory and/or memory element 606 may be a single memory device, a plurality of memory devices, and/or embedded circuitry of the processor 604. Such a memory device may be a read-only memory, random access memory, volatile memory, non-volatile memory, static memory, dynamic memory, flash memory, cache memory, and/or any device that stores digital information. The memory 606 is capable of storing machine readable instructions such that the machine readable instructions can be accessed by the processor 604. The machine readable instructions can comprise logic or algorithm(s) written in programming languages, and generations thereof, (e.g., 1GL, 2GL, 3GL, 4GL, or 5GL) such as, for example, machine language that may be directly executed by the processor 604, or assembly language, object-oriented programming (OOP), scripting languages, microcode, etc., that may be compiled or assembled into machine readable instructions and stored on the memory 606. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods and devices described herein may be implemented in any conventional computer programming language, as pre-programmed hardware elements, or as a combination of hardware and software components.

Note that when the processor 604 includes more than one processing device, the processing devices may be centrally located (e.g., directly coupled together via a wired and/or wireless bus structure) or may be distributed located (e.g., cloud computing via indirect coupling via a local area network and/or a wide area network). Further note that when the processor 604 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element stores, and the processor 604 executes, hard coded and/or operational instructions corresponding to at least some of the steps and/or functions illustrated in FIGS. 1-7 for effecting an autonomous control handover.

The wireless communication interface 602 generally governs and manages the vehicle user input data via the vehicle network 412 over the communication path 413 and/or wireless communication 434 and/or 438. The wireless communication interface 602 also manages controller unit output and input data including autonomous control handover request 403, autonomous control data 456, perception-and-cognition result 512 sensor data 416, autonomous control handover response 460, and data requests, such as map layer data requests, etc.

There is no restriction on the present disclosure operating on any particular hardware arrangement and therefore the basic features herein may be substituted, removed, added to, or otherwise modified for improved hardware and/or firmware arrangements as they may develop.

In operation, the vehicle control unit 400 functions to effect an autonomous control handover, in which the vehicle control unit 400 may detect an autonomous control handover event and a handover transition period. Upon detecting the autonomous control handover event, the autonomous control handover event prompts a transition from a first vehicle automation level to a second vehicle automation level, such as that discussed in detail with reference to FIGS. 2-7.

FIG. 7 shows an example process 700 for effecting an autonomous control handover. At operation 702, a vehicle control unit may detect an autonomous control handover event. An autonomous control event may include receiving an autonomous control handover request from a user, a vehicle operator, a third-party server application, and may also be based on detecting an adverse driving condition event such as upcoming construction, roadway congestion, adverse weather conditions, vehicle system overload detection, etc.

In response to the detection of the autonomous control handover event—the vehicle control unit at operation 704 polls vehicle operator presence data, which may be accessible via a vehicle operator presence array, and at operation 706 compares the vehicle operator presence data (such as driver seat sensor device data, seat belt sensor device data, seat angle sensor device data, head restraining sensor device data, etc.) with a presence threshold to produce a vehicle operator presence determination.

As may be appreciated, the presence threshold may be based on a singular and/or multiple values indicative to an operator occupying a vehicle driver seat. For example, the presence threshold may be based on desired measured values, such as weight values indicative of an adult occupying the driver seat, a seat angle sensor value indicating a value and/or range of values indicating a sufficiently upright position to operate the vehicle. Other values may be binary in nature, such as a seat belt value and/or head restraint value “TRUE” when engaged or “FALSE” when not engaged. The values for each may be cumulative, weighted, or subsets used to determine the vehicle operator presence.

When the vehicle operator presence determination operates to indicate a current presence of a vehicle operator at operation 708, the vehicle control unit assesses a perception-and-cognition of the vehicle operator in operations 710 and 712. In this regard, the vehicle control unit operates to verify, in effect, a mental readiness of the operator for the driving task. Engagement and/or a touch by the operator of the vehicle human-machine interface devices (such as a steering wheel, accelerator pedal, brake pedal, etc.) alone may not convey a mental readiness of the vehicle operator to assume priority control over a vehicle.

For example, a vehicle operator may not have a sufficient level of mental readiness due to waking from a nap, general inattentiveness, or unknowingly having the steering wheel misaligned with the current direction of travel by the vehicle control unit, and/or the accelerator pedal not engaged at a level to continue the existing speed, acceleration and/or deceleration controlled by the vehicle control unit.

Also, driving skill sets may degrade over time because a vehicle operators may become over-reliant on autonomous vehicle technologies (such as at first vehicle automation Levels L3, L3 and/or L4 (FIG. 2)). That is, vehicle operators may have less hands-on practice manually controlling the vehicle.

At operation 710, while at a first vehicle automation level, (such as Level L3, Conditional Automation, Level L4 High Automation and/or Level L5 Full Automation (FIG. 2)), the vehicle control unit operates to sample user control data to produce simulated user control data.

In context, a vehicle HMI device(s) may generate user control data that can be sensed by sensor devices; however, while in Level L3, Level L4 and/or Level L5 operation, an engine control unit and/or powertrain may not operate on some or all of the user control data, and be disregarded (or discarded) because control priority accompanies commands and/or control signals received via the vehicle control unit.

The vehicle control unit may operate to simulate the vehicle operator inputs via the HMI device(s) 303, 305, as sensed via the human-machine interface array 450, which may include a steering wheel sensor device 304 to produce data 416-304, a speed sensor device 306 to produce data 416-306, and a brake pedal sensor device 308 to produce data 416-308 (FIG. 4). In operation, while at a first vehicle automation level (which may be one of Level L3, Level L4 or Level L5 per the example of FIG. 2), the vehicle control unit 400 may operate to sample user control data 458 generated via a human-machine interface device(s) 303, 305, to produce simulated user control data.

At operation 712, the vehicle control unit compares simulated user control data with corresponding vehicle autonomous control data, and may generate a perception-and-cognition result. At operation 714, when the simulated user control data compares favorably with the vehicle autonomous control data, and a handover transition period has not lapsed, the vehicle control unit at operation 716 generates an autonomous control handover response operable to transition from the first vehicle automation level to the second vehicle automation level.

At operation 718, the vehicle control unit operates to transmit the autonomous control handover response. The response may be transmitted be via the network 412 (FIG. 4) to be received by, and acted upon, by control units of the vehicle to effect the autonomous control handover, such as control units relating to the vehicle powertrain, that may include an engine control unit (ECU), a transmission control unit, guidance control unit, etc. Also, the autonomous control handover response may be received by graphical user interface devices to announce the handover status to requesting devices, such as via a handheld mobile device 436, a third-party server 433, a head unit device 402, etc. Moreover, the response may be broadcast via vehicle-to-vehicle (V2V) wireless communications to advise other vehicles of the handover, as well as to roadway infrastructure via vehicle-to-infrastructure wireless communications, etc.

While particular combinations of various functions and features of the present invention have been expressly described herein, other combinations of these features and functions are possible that are not limited by the particular examples disclosed herein are expressly incorporated within the scope of the present invention.

As one of ordinary skill in the art may appreciate, the term “substantially” or “approximately,” as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items range from a difference of a few percent to magnitude differences.

As one of ordinary skill in the art may further appreciate, the term “coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “coupled.”

As one of ordinary skill in the art will further appreciate, the term “compares favorably,” as may be used herein, indicates that a comparison between two or more elements, items, signals, et cetera, provides a desired relationship. For example, when the desired relationship is that a first signal has a greater magnitude than a second signal, a favorable comparison may be achieved when the magnitude of the first signal is greater than that of the second signal, or when the magnitude of the second signal is less than that of the first signal.

As the term “module” is used in the description of the drawings, a module includes a functional block that is implemented in hardware, software, and/or firmware that performs one or more functions such as the processing of an input signal to produce an output signal. As used herein, a module may contain submodules that themselves are modules.

Thus, there has been described herein a device and method, as well as several embodiments, for effecting an autonomous control handover of a vehicle from a first vehicle automation level to a second vehicle automation level involving return of vehicle control priority to a vehicle operator.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretations so as to encompass all such modifications and equivalent structures as is permitted under the law.

What is claimed is:

1. A method in a vehicle control unit for effecting an autonomous control handover, the method comprising:
detecting an autonomous control handover event and a handover transition period, the autonomous control handover event prompting a transition from a first vehicle automation level to a second vehicle automation level, wherein the first vehicle automation level defines a priority vehicle control to relate to the vehicle control unit, and the second vehicle automation level defines the priority vehicle control to relate to a vehicle operator;
polling, in response to the autonomous control handover event, vehicle operator presence data;
comparing the vehicle operator presence data with a presence threshold to produce a vehicle operator presence determination;
when the vehicle operator presence determination operates to indicate a current presence of a vehicle operator, assessing a perception-and-cognition of the vehicle operator by:
while at the first vehicle automation level, sampling user control data generated via a human-machine interface device and producing simulated user control data;
comparing the simulated user control data with corresponding autonomous control data generated via the vehicle control unit;
when the simulated user control data compares favorably with the corresponding autonomous control data and the handover transition period has not lapsed, generating an autonomous control handover response operable to transition to the second vehicle automation level; and
transmitting the autonomous control handover response.

2. The method of claim 1, wherein the autonomous control handover event comprising at least one of:
receiving an autonomous control handover request;
detecting an adverse driving condition event; and
detecting a vehicle system overload event.

3. The method of claim 1, wherein the human-machine interface device comprising at least one of:
a steering wheel sensor device, wherein the user control data including steering wheel angle data;
an accelerator pedal sensor device, wherein the user control data including accelerator position data; and
a brake pedal sensor device, wherein the user control data including brake pedal position data.

4. The method of claim 1, wherein the presence threshold comprising at least one of:
driver seat sensor value;
seat belt sensor value;
seat angle sensor value; and
head restraint sensor value.

5. The method of claim 1, further comprising:
presenting to the vehicle operator a perception-and-cognition result from the comparing of the simulated user control data and the autonomous control data via at least one of a visual feedback and an audio feedback.

6. The method of claim 1, wherein the first vehicle automation level comprising:
a limited self-driving automation level; and
a full self-driving automation level.

7. The method of claim 1, wherein the second vehicle automation level comprising:
a combined function automation level;
a function-specific automation level; and
a no automation level.

8. A method in a vehicle control unit for effecting an autonomous control handover, the method comprising:
detecting an autonomous control handover event, the autonomous control handover event prompting a transition from a first vehicle automation level to a second vehicle automation level, wherein the first vehicle automation level defines a priority vehicle control to relate to the vehicle control unit, and the second vehicle automation level defines the priority vehicle control to relate to a vehicle operator;
in response to the autonomous control handover event, assess a perception-and-cognition of a vehicle user by:
sampling operator control data generated via a human-machine interface device while at the first vehicle automation level to produce sampled operator control data;
comparing the sampled operator control data with corresponding vehicle control data generated via the vehicle control unit;
when the sampled operator control data compares favorably with the corresponding vehicle control data, generating an autonomous control handover response operable to place a vehicle at the second vehicle automation level to assign the priority vehicle control with the vehicle operator; and
transmitting the autonomous control handover response.

9. The method of claim 8, wherein the autonomous control handover event comprising at least one of:
receiving an autonomous control handover request;
detecting an adverse driving condition event; and
detecting a vehicle system overload event.

10. The method of claim 8, wherein the detecting the autonomous control handover event further comprising:
determining a handover transition period to effect the autonomous control handover; and
the transmitting the autonomous control handover response occurs when the handover transition period has not lapsed.

11. The method of claim 8, wherein the human-machine interface device comprising at least one of:
a steering wheel sensor device, wherein the operator control data including steering wheel angle data;
an accelerator pedal sensor device, wherein the operator control data including accelerator position data; and
a brake pedal sensor device, wherein the operator control data including brake pedal position data.

12. The method of claim 8, further comprising:
presenting to the vehicle operator a perception-and-cognition result from the comparing the sampled operator control data with the corresponding vehicle control data via at least one of a visual feedback and an audio feedback.

13. The method of claim 8, wherein the first vehicle automation level comprising at least one of:
a limited self-driving automation level; and
a full self-driving automation level.

14. The method of claim 8, wherein the second vehicle automation level comprising at least one of:
a combined function automation level;
a function-specific automation level; and
a no automation level.

15. A vehicle control unit for effecting an autonomous control handover, the vehicle control unit comprising:
a wireless communication interface to service communication with a vehicle network;
a processor coupled to the wireless communication interface, the processor for controlling operations of the vehicle control unit; and
a memory coupled to the processor, the memory for storing data and program instructions used by the processor, the processor configured to execute instructions stored in the memory to:
detect an autonomous control handover event, the autonomous control handover event operates to prompt a transition from a first vehicle automation level to a second vehicle automation level, wherein the first vehicle automation level defines a priority vehicle control to relate to the vehicle control unit, and the second vehicle automation level defines the priority vehicle control to relate to a vehicle operator;
assess a perception-and-cognition of the vehicle operator by:
sampling operator control data generated via a human-machine interface device while at the first vehicle automation level to produce sampled operator control data;
comparing the sampled operator control data with corresponding vehicle control data generated via the vehicle control unit;
when the sampled operator control data compares favorably with the corresponding vehicle control data, generating an autonomous control handover response operable to place a vehicle at the second vehicle automation level to assign the priority vehicle control with the vehicle operator; and
transmitting the autonomous control handover response.

16. The vehicle control unit of claim 15, wherein the autonomous control handover event comprising at least one of:
an autonomous control handover request;
an adverse driving condition event; and
a vehicle system overload event.

17. The vehicle control unit of claim 15, wherein the human-machine interface device comprising at least one of:
a steering wheel sensor device, wherein the operator control data includes steering wheel angle data;
an accelerator pedal sensor device, wherein the operator control data includes accelerator position data; and
a brake pedal sensor device, wherein the operator control data includes brake pedal position data.

18. The vehicle control unit of claim 15, wherein the processor being further configured to execute further instructions stored in the memory to sample the operator control data by:
presenting to the vehicle operator a perception-and-cognition result from the comparing of the sampled operator control data with the corresponding vehicle control data via at least one of a visual feedback and an audio feedback.

19. The vehicle control unit of claim 15, wherein the first vehicle automation level comprising at least one of:
a limited self-driving automation level; and
a full self-driving automation level.

20. The vehicle control unit of claim 15, wherein the second vehicle automation level comprising at least one of:
a combined function automation level;
a function-specific automation level; and
a no automation level.
